(19) United States
(12) Patent Application Publication
(10) Pub. No.: US 2011/0137515 A1
(43) Pub. Date: Jun. 9, 2011

(54) METHOD FOR OPERATING A HYDRAULIC OR PNEUMATIC CONTROL DEVICE OF A SEMI-AUTOMATIC TRANSMISSION

(75) Inventors: Mario Steinborn, Friedrichshafen (DE); Alfred Bruhn, Karlsruhe (DE); Rainer Petzold, Friedrichshafen (DE)

(73) Assignee: ZF FRIEDRICHSHAFEN AG, Friedrichshafen (DE)

(21) Appl. No.: 13/058,555

(22) PCT Filed: Jul. 9, 2009
(86) PCT No.: PCT/EP2009/058713

§ 371 Date: Feb. 11, 2011

(30) Foreign Application Priority Data
Aug. 20, 2008 (DE) 10 2008 041 399.2

(51) Int. Cl. F16H 61/12

(52) U.S. Cl. 701/29

(57) ABSTRACT

A method of operating a hydraulic or a pneumatic control device of a semi-automatic transmission. The control device has actuator devices with actuating cylinders. Pressure chambers of the actuating cylinders can each be connected, via a control valve, with a pressure line that can be selectively connected with a main pressure line, or blocked, via redundant and parallel positioned main switching valves. The control device has at least one sensor and at least one measured signal is captured by the at least one sensor, depending on the actuation of the main switching valves. The at least one measured signal or each captured measured signal is compared to a stored nominal signal for the respective actuation of the main switching valves and, if a deviation is determined between the measured signal and the respective nominal signal, a defect of at least one of the main switching valves is concluded.

The invention concerns a method for operating a hydraulic or pneumatic control device of a semi-automatic transmission in accordance with the preamble of claim 1.

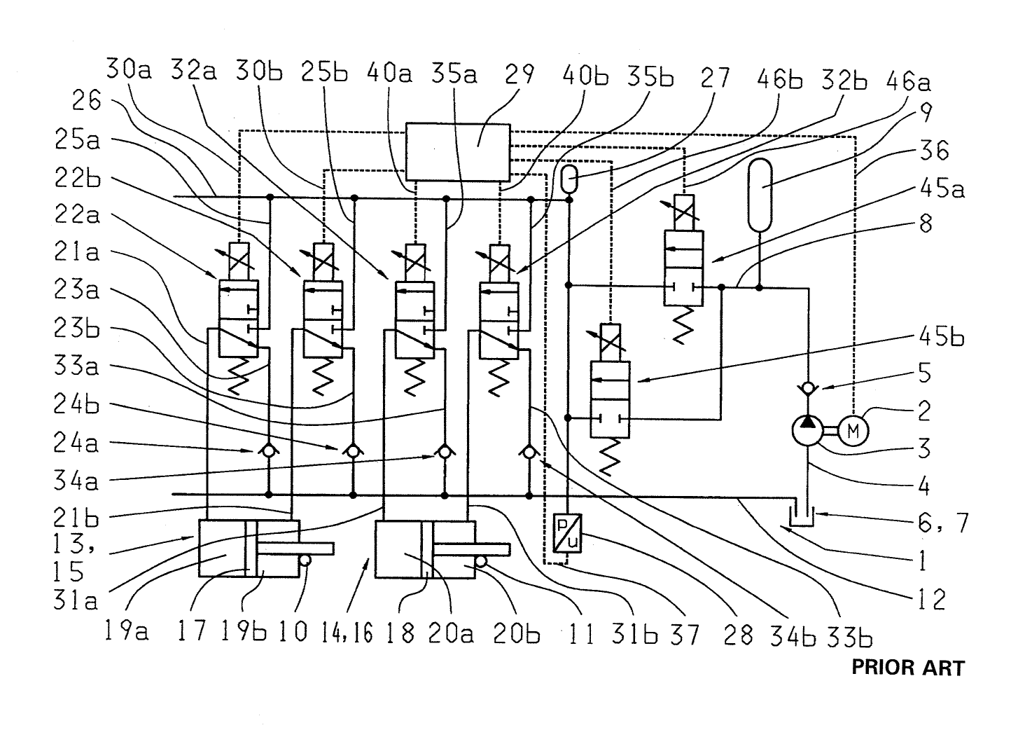

From the DE 10 2006 040 476 A1, a hydraulic or rather pneumatic control device 1 of a semi-automatic transmission of a vehicle is known as presented in FIG. 1. The control device 1, as presented in FIG. 1, comprises a motor 2 which drives a pump 3 to move a pressurizing agent, for instance hydraulic oil or pressured air, via a suction line 4 and a check valve 5, from a storage tank 6, or oil sump 7, respectively, into a main pressure line 8. To compensate for variations in pressure, a pressure reservoir 9 is connected to the main pressure line 8. The control device as in FIG. 1 comprises several actuator devices, wherein just two actuator devices 13 and 14 are shown here. The actuator devices 13 and 14, which can be designed as a selective actuator and a mechanical actuator, or just as mechanical actuators, are each formed as a hydraulic cylinder 15, 16, each having pressure chambers 19a, 19b, or 20a, 20b, separated by a respective piston 17, 18. The pressure chambers 19a, 19b of the first actuator device 13 are each connected, via a connecting line 21a, 21b, with the outlet of a control valve 22a, 22b which is designed as a 3/2 directional magnetic switching valve. Via the control valve 22a, the first pressure chamber 19a of the actuated device 13 can be selectively linked, via a return line 23a and a check valve 24a, with the pressureless line 12 or, via an inflow line 35a, with the pressure line 26. Also, the second pressure chamber 19b of the actuator device 13, by means of the assigned control valve 22b, can be selectively linked, via a return line 23b and a check valve 24b, with the pressureless line 12 or, via the inflow line 25b, with the pressure line 26.

In the same manner, the pressure chambers 20a and 20b of the actuator devices 14 are each connected, via a connecting line 31a, 31b, with the outlet of a control valve 32a, 32b which is designed as a 3/2 way magnetic switching valve. Through the assigned, first control valve 32a, the first pressure chamber 20a of the actuator device 14 can be selectively connected, via a return line 33a and a check valve 34a with the pressureless line 12, or can be connected, via an inflow line 35a, with the pressure line 26. Also, the second pressure chamber 20b of the actuator device 14 can be selectively connected with the pressureless line 12, via the assigned second control valve 32b and either a return line 33b and a check valve 34b, or the pressure line 26 via an inflow line 35b.

In compensating for pressure variations, a pressure reservoir 27 is connected to the pressure line 26. In addition, a pressure sensor 28 is connected to the pressure line 26, which can, for instance, be used for measuring the activated pressure in the pressure chambers 19a, 19b, 20a, 20b of the actuator devices 13, 14. A control device 29, preferably designed as an electronic device, is connected, via electric control lines 30a, 30b, 40a, 40b, with the control valves 21a, 21b, 31a, 31b and, via an additional electric control line 36, the control device 29 is connected with the motor 2 and, via a sensor line 37, with the pressure sensor 28.

Additionally, as shown in FIG. 1, the example embodiment of the control device 1 has two, parallel positioned main switching valves 45a and 45b, which are positioned between the main pressure line 8 and the pressure line 26. The main switching valves 45a and 45b are each, in accordance with FIG. 1, designed as 2/2 way magnetic switching valves and are each connected, via an electric control line 46a, 46b, with the control device 29, so that they can be actuated independently of each other.

Thus, the control device 1 of FIG. 1 has redundant main shut off valves 45a, 45b, whereby in the event that one of the main switching valves 45a or 45b fails, the non-malfunctioning main switching valve 45b or 45a can maintain the functionality of the control device 1, however, with reduced dynamics, such as prolonged shifting times of the automated transmission which contains the control device.

It is also already known to provide the hydraulic cylinders 15, 16 with path sensors 10, 11 such that the situation of the hydraulic cylinders 15, 16 can be monitored.

If the control device 1 in FIG. 1 requires a functional test of the main switching valves 45a, 45b, as commonly known in the practice, the main switching valves 45a, 45b are activated, via the electronic control device 29, to perform electric or rather electronic diagnostics or functional testing of the main switching valves 45a and 45b. Such diagnostics of the main switching valves 45a and 45b cannot be performed during the regular operation of the control device 1. Therefore, a need exists for a method to operate such a control device, whereby a diagnosis or functional test, respectively, of the main switching valves 45a and 45b is possible, even during the regular operation of the control device.

In consideration of the above, the present invention is based on the problem to create a novel method for operating a hydraulic or pneumatic control device in a semi-automatic transmission.

The problem is solved with the method in accordance with claim 1.

In accordance with the invention, at least one measured signal is captured by means of a sensor or from each of the sensors, depending on the activation of the main switching valves, whereby the measured signal or each of the measured signals is compared to a stored nominal signal for the respectively activated main switching valves, and if a deviation between the measured signal and the respective nominal signal has been determined, it is concluded that a malfunction has occurred in at least one of the main switching valves.

In the inventive method, the diagnostic or functional test, respectively, of the main switching valves takes place indirectly through evaluation of measured signals from at least one sensor of the control device 1.

It is hereby possible to perform, even during the regular operation of the control device, a functional test and therefore a diagnosis of the main switching valves.

Preferred, additional embodiments of the invention are presented in the dependent claims and the following description. The embodiments of the invention are explained in more detail with reference to the drawings, but are not limited thereto. It shows:

FIG. 1 a schematic representation of a hydraulic or pneumatic control device of a semi-automatic transmission for the further clarification of the invented method.

In the following, the inventive method for operating a hydraulic or pneumatic control device of an automatic transmission is described with reference to FIG. 1.

In the sense of this present invention, the functional diagnosis or the functional test, respectively, of the main switching valves 45a, 45b of the control device 1 as shown in FIG. 1 does not take place through electric or electronic activation of the control device by means of the control device 29, but by means of at least one sensor, depending on the activation of the main switching valves 45a, 45b, and by capturing a measured signal, whereby one or all measured signals are compared to a stored nominal signal for the respective activation of the main switching valves 45a, 45b, and then, if a deviation is determined between a measured signal and the respective nominal signal, a defect of at least one of the main switching valves 45a, 45b is concluded.

It is therefore possible to measure, for instance, by means of the pressure sensor 28 which is connected to the pressure line 26, between the main switching valves 45a, 45b and the control valves 22a, 22b, 32a, 32b, depending on the activation of the main switching valves 45a, 45b, a pressure and/or a pressure gradient, and to compare the measured pressure and/or pressure gradient with a stored nominal pressure for the respective activation of the main switching valves, and/or to compare it with the stored nominal pressure gradient of the respective activation of the main switching valves 45a, 45b.

At the time, when a deviation between the measured pressure and/or the measured pressure gradient and the stored nominal pressure and/or the stored nominal pressure gradient has been determined, a malfunction, in accordance with the invention, is concluded in at least one of the main switching valves 45a, 45b.

As an alternative or in addition, this indirect diagnosis or functional test, respectively, of the main switching valves 45a, 45b, can also be performed through the analysis of measured signals of the path sensors 10, 11.

In this case, and depending on the actuation of the main switching valves 45a, 45b, the displacement of each particular hydraulic cylinder 15, 16 is measured by means of the path sensor 10, 11, whereby the measured regulating distances are compared to the stored nominal and the stored regulating distances for each particular actuation of the main switching valves 45a, 45b, and whereby then, if a deviation has been determined between the measured displacement and the nominal displacement, a malfunction is concluded in at least one of the main switching valves 45a, 45b.

In the following, it is assumed for FIG. 1 that the inventive, indirect functional diagnosis of the main switching valves 45a, 45b takes place by means of the pressure sensor 28, whereby when the main switching valves 45a, 45b are not actuated and are therefore closed, a minimal pressure is predetermined as the nominal pressure for the pressure sensor 28, and when the main switching valves 45a and 45b are actuated and are therefore open, a nominal pressure is predetermined for the pressure sensor 28 as a maximum pressure and stored, as well as a maximum pressure gradient for the nominal pressure gradient, and when one of the two main switching valves 45a and 45b is actuated and therefore open and the other is not actuated and is therefore closed, a maximum pressure is stored as the nominal pressure, and a smaller gradient than the maximum pressure is stored as the nominal pressure gradient. The nominal values for the pressure and the pressure gradient for two functioning main switching valves 45a, 45b are presented in table 1.

TABLE 1

| Main switching | Main switching | Nominal pressure | |
|---|---|---|---|
| valve 45a | valves 45b | gradient | Nominal pressure |
| Open | Open | Maximum | Maximum |
| Open | Closed | Maximum | Less than maximum |
| Closed | Open | Maximum | Less than maximum |
| Closed | Closed | Minimum | Zero |

For instance, if one of the main switching valves 45a, 45b is functioning and the other main switching valve 45b or 45a, respectively, cannot be activated but is open, thus, by means of the measured signal of the pressure sensor 28, a functional diagnosis of the main switching valves 45a, 45b can be performed in a way that at the time, when the defective main switching valve 45a or 45b, respectively, cannot be actuated and is therefore closed, the pressure sensor 28 will measure a pressure and/or pressure gradient which deviates from the nominal pressure and/or nominal pressure gradient. The following Table 2 shows as an example, a condition for a defective or non-actuating main switching valve 45b which is permanently open, whereby deviations from the nominal condition (Table 1) are highlighted for two functioning main switching valves 45a, 45b by underlining.

TABLE 2

| Main | Main switching | Measured | Measured pressure |
|---|---|---|---|
| switching valve 45a | valves 45b | pressure | gradient |
| Open | Open | Maximum | Maximum |
| Open | defect (open) | Maximum | Maximum |
| Closed | Open | Maximum | Less than maximum |
| Closed | defect (open) | Maximum | Less than Maximum |

The same is the case when one of the two main switching valves 45a or 45b, respectively, is defective and permanently closed. The following Table 3 shows as an example, the condition for a defective or non-actuating, permanently closed main switching valve 45b, whereby deviations from the nominal condition (Table 1) for two functioning main switching valves 45a, 45b are highlighted through underlining.

TABLE 3

| Main | Main switching | Measured | Measured pressure |
|---|---|---|---|
| switching valve 45a | valves 45b | pressure | gradient |
| Open | defect (closed) | Maximum | Less than maximum |
| Open | closed | Maximum | Less than maximum |
| Closed | defect (closed) | Minimum | Zero |
| Closed | closed | Minimum | Zero |

### REFERENCE CHARACTERS

1 Control Device
2 Motor
3 Pump
4 Suction Line
5 Check Valve
6 Storage Tank
7 Oil Sump
8 Main Pressure Line
9 Pressure Reservoir
10 Path Sensor
11 Path Sensor
12 Non-Pressure Line
13 Actuator Device
14 Actuator Device
15 Actuating Cylinder
16 Actuating Cylinder
17 Piston
18 Piston
19a, 19b Pressure Chamber
20a, 20b Pressure Chamber
21a, 21b Connecting Line
22a, 22b Control Valve
23a, 23b Return Line
24a, 24b Check Valve
25a, 25b Inflow Line
26 Pressure Line
27 Pressure Reservoir
28 Pressure Line
29 Control Device
30a, 30b Control Line
31a, 31b Connecting Line
32a, 32b Control Valve
33a, 33b Return Line
34a, 34b Check Valve
35a, 35b Inflow Line
36 Control Line
37 Sensor Line
40a, 40b Control Line
45a, 45b Main Switching Valve
46a, 46b Control Line

1-3. (canceled)

4. A method of operating one of a hydraulic and a pneumatic control device of a semi-automatic transmission, the control device comprising actuators with actuating cylinders, pressure chambers of the actuating cylinders being connectable, via a control valve, with a pressure line, the pressure line one of being selectively connectable via redundant main switching valves that are positioned in parallel with a main pressure line and being shut off from the main pressure line, and the control device having at least one sensor, the method comprising the steps of:
capturing via at least one sensor, depending on actuation of the main switching valves, at least one measured signal,
comparing the at least one measured signal that is captured to a stored nominal signal of the respective actuation for the main switching valves, and
if a deviation is determined between the at least one measured signal and the respective stored nominal signal, concluding a defect in at least one of the main switching valves.

5. The method according to claim 4, further comprising the steps of:
connecting at least one positioned pressure sensor which to the pressure line, between the main switching valves and the control valves,
measuring at least one of a pressure and a pressure gradient,
comparing the at least one of the measured pressure and the measured pressure gradient to a respective one of a stored nominal pressure for the respective actuation of the main switching valves or a nominal pressure gradient for the respective actuation of the main switching valves, and
if a deviation is determined between the at least one of the measured pressure and the measured pressure gradient and the stored nominal pressure and the deposited nominal pressure gradient, concluding a defect in one of the main switching valves.

6. The method according to claim 4, further comprising the steps of providing each actuating cylinder with at least an assigned path sensor, and, depending on the actuation of the main switching valves,
measuring an adjusted distance of each actuating cylinder,
comparing the measured adjusted distance to stored nominal adjusted distance values of the respective actuation of the main switching valves, and
if a deviation is determined between the measured adjusted distance and the nominal adjusted distance, concluding a defect of at least one of the main switching valves.

7. A method of operating one of a hydraulic control device and a pneumatic control device of a semi-automatic transmission, the control device comprising actuators having actuating cylinders, the actuating cylinders comprising pressure chambers that are respectively connectable, via a control valve, with a pressure line, two main switching valves being located in parallel and coupling the pressure line with a main pressure line, the two main switching valves being selectively actuatable to open and close such that the pressure line communicates with the main pressure line when at least one of the two main switching valves is open and communication between the pressure line and the main pressure line is prevented when both of the two main switching valves are closed, the method comprising the steps of:
detecting at least measured signal with at least one sensor depending on the actuation of the main switching valves;
comparing the at least one measured signal to a respective stored nominal signal of the respective actuation of the main switching valves; and
concluding that at least one of the two main switching valves is defective if a deviation between the at least one measured signal and the respective stored nominal signal is determined.

8. The method according to claim 7, further comprising the steps of:
connecting the at least one sensor to the pressure line between the main switching valves and the control valves, and the at least one sensor being a pressure sensor;
measuring a pressure of the pressure line with the pressure sensor;
comparing the measured pressure to a stored nominal pressure for the respective actuation of the main switching valves; and
concluding that at least one of the two main switching valves is defective if a deviation between the measured pressure and the stored nominal pressure is determined.

9. The method according to claim 7, further comprising the steps of:
connecting the at least one sensor to the pressure line between the main switching valves and the control valves, and the at least one sensor being a pressure sensor;
measuring a pressure gradient of the pressure line with the pressure sensor;
comparing the measured pressure gradient to a stored nominal pressure gradient for the respective actuation of the main switching valves; and
concluding that at least one of the two main switching valves is defective if a deviation between the measured pressure gradient and the stored nominal pressure gradient is determined.

10. The method according to claim 7, further comprising the steps of:
assigning the at least one sensor to the actuating cylinders, and the at least one sensor being a path displacement sensor;
measuring a displacement of the actuating cylinders;
comparing the measured displacement of the actuating cylinders to a stored nominal displacement of the actuating cylinders for the respective actuation of the main switching valves; and
concluding that at least one of the two main switching valves is defective if a deviation between the measured displacement of the actuating cylinders and the stored nominal displacement of the actuating cylinders is determined.
